(19) United States
(12) Patent Application Publication
(10) Pub. No.: US 2013/0135080 A1
(43) Pub. Date: May 30, 2013

(54) TAG FORGERY PROTECTION

(71) Applicant: Juhani Virtanen, Tampere (FI)

(72) Inventor: Juhani Virtanen, Tampere (FI)

(73) Assignee: UPM RFID OY, Pirkkala (FI)

(21) Appl. No.: 13/305,014

(22) Filed: Nov. 28, 2011

(51) Int. Cl. G06F 7/04

(52) U.S. Cl. 340/5.8

(57) ABSTRACT

A method for determining the authenticity of an article including a microchip package, wherein the microchip package includes a sensing element. The method includes receiving a value of a measurable quantity. The value of the measurable quantity is measured using the sensing element. The value of the measurable quantity is indicative of an environment. Reference information indicative of the environment I received. The received value of a measurable quantity and the reference information are used to determine the authenticity of the article comprising the microchip package. A computer program product including a non-transitory computer readable medium and computer program code which when executed by a data processor is for executing the method. An apparatus for determining the authenticity of an article including a microchip package including a sensing element.

### FIELD OF THE INVENTION

The invention relates to preventing the forgery of articles comprising a microchip package. An embodiment of the invention relates to preventing forgery of an RFID chip.

### BACKGROUND OF THE INVENTION

Forgery and its prevention have attracted people for centuries. In particular, security documents such as passports, banknotes, and various types of identity cards, have been copied for long time. Moreover, commercial goods, such as clothing, software products, watches, to name a few, are commonly forged. Forgery is commonly prevented by making the product, or a product identity hard to copy.

Electronic devices have given partial solution to the problem. In particular, products comprising a microchip may comprise information indicative of the product in the chip, e.g. in the microchip's memory. Such microchips may be comprised in a tag, which may be attached to an article, or integrated, e.g. laminated, in a security document.

As an example, an identity card may comprise a microchip comprising memory, and the memory may comprise a digital image of the person or a digital image of the fingerprint of the person. Typically, such a microchip may comprise a digital identity number of the chip itself. Still further, a database may comprise information indicative of which microchip should be attached to which identity card. The digital identity of the microchip may be permanently coded to the microchip, thereby making it impossible to change the microchip of the identity card, assuming that all microchips have unique digital identity. The chip manufacturer takes responsibility of not selling different microchips with the same digital identity.

As another example, where a lower level of security is needed, a commercial article may be equipped with a microchip, the microchip containing in its memory digital information of the commercial article. The microchips themselves are harder to copy than a conventional trademark. Furthermore, arrangements, where a part of a microcircuit is destroyed, when a package is opened, are known, thereby enabling a tamper-proof product label.

Even if this kind of electronic prevention makes counterfeiting harder, it is still possible to copy the microchip itself. Moreover, a dishonest microchip manufacturer may produce microchips with a programmable or programmed digital identity. Thereafter, copying the chip identity in principle comprises only reading information from the chip to be copied and writing the information to the programmable chip. In prior art, such copying is being retarded by using a timer to lock memory, as disclosed in the publication GB 2474296.

### SUMMARY OF THE INVENTION

A method for determining the authenticity of an article comprising a microchip package is disclosed. It has been noticed that a microchip may comprise a sensing element that changes its output in response to the environment where the microchip is located. The relation between the output and the environment may depend on the physical properties of the microchip and/or the sensing element. This property is be utilized in the invention. Therefore, the microchip package in the invention comprises a sensing element. The method comprises
receiving a value of a measurable quantity, the value of the measurable quantity being measured using the sensing element, and the value of the measurable quantity being indicative of an environment,
receiving reference information indicative of the environment, and
using the received value of a measurable quantity and the reference information to determine the authenticity of the article comprising the microchip package.

In an embodiment, the value of the measurable quantity is compared with a reference value for the measurable quantity. In another embodiment, calibration data is used to determine the value of an environment parameter, and the value of the environment parameter is compared with a reference for the environment parameter. In addition, the comparison of several measurable quantities or environment parameters with their reference values may be done. Comparison of multiple values may be done on statistical basis. Furthermore, calibration data may be compared with a reference for the calibration data. Still further, for an authentic microchip package the value of the measurable quantity or calibration data may have a logical correspondence with the identity of the microchip package. The authenticity may be further ensured by checking whether this condition is met or not. For a set of microchip packages, the condition may be met only for a given portion of the microchip packages.

The method may be implemented as a computer program comprising computer program code, which when executed by a data processor is for executing the method. The computer program may be supplied as a computer program product comprising computer program code embodied on a non-transitory computer-readable medium.

An apparatus may be used for determining the authenticity of an article comprising a microchip package, the microchip package comprising a sensing element. The apparatus comprises
means for receiving a value of a measurable quantity, the value of the measurable quantity being measured using the sensing element, and the value of the measurable quantity being indicative of an environment,
means for receiving reference information indicative of the environment, and
a data processor, arranged to use the received value of a measurable quantity and the reference information to determine the authenticity of the article comprising the microchip package.

The apparatus may comprise a reader device arranged to receive the value of a measurable quantity. The apparatus may comprise a sensor arranged to measure a reference value for the environment parameter. The apparatus may comprise means for accessing a database or an interface using the measured reference value for the environment parameter. The apparatus may comprise means for receiving an identity of the microchip package and means for accessing a database or an interface using the identity of the microchip package. The database may comprise calibration data for the microchip package. The interface may be configured to be accessed for receiving calibration data of the microchip package. The apparatus may comprise means for receiving multiple values of a measurable quantity, the values of the measurable quantity being measured from a set of articles comprising a microchip package, the microchip packages comprising a sensing element, the set of articles comprising the article comprising a microchip package. The data processor may be arranged to calculate a statistical measure of difference using the received multiple values of a measurable quantity and the reference information and the data processor may be arranged to determine the authenticity of a microchip package using the statistical measure of difference.

### DESCRIPTION OF THE DRAWINGS

FIG. 1a shows an RFID transponder and an RFID reader, wherein the RFID transponder comprises a microchip comprising a local oscillator as a sensing element,

FIG. 1b shows an RFID transponder and an RFID reader, wherein the RFID transponder comprises a microchip comprising a sensing element,

FIG. 1c shows an RFID transponder and an RFID reader, wherein the RFID transponder comprises a microchip package comprising a microchip and a sensing element attached to the microchip,

FIG. 2 shows a portion of an interrogation signal sent from a reader,

FIG. 3a shows modulation frequency as a function of the frequency-setting parameter TRcal of an interrogation signal,

FIG. 3b shows the dependence of a frequency of a local oscillator on temperature,

FIG. 3c shows modulation frequency as a function of the frequency-setting parameter TRcal of an interrogation signal in three different temperatures,

FIG. 3d shows the dependence of a measurable quantity on temperature, wherein the measurable quantity is one of frequency, resistivity, voltage, and the frequency-setting parameter TRcal0 corresponding to a frequency jump,

FIG. 4 shows steps for determining the authenticity of an article comprising a microchip package, wherein a value of a measurable quantity is compared with its reference value,

FIG. 5 shows steps for producing a database used for determining the authenticity of an article comprising a microchip package,

FIG. 6 shows steps for determining the authenticity of an article comprising a microchip package, wherein two values of a measurable quantity are compared with their reference values, the values corresponding to different environments,

FIG. 7 shows steps for determining the authenticity of an article comprising a microchip package, wherein a value describing the environment is deduced using a value of a measurable quantity and calibration data, and the value describing the environment is compared with its reference value,

FIG. 8 shows steps for determining the authenticity of an article comprising a microchip package, wherein a value describing the environment is deduced using calibration data, the value describing the environment is compared with its reference value, and calibration data is compared with reference calibration data,

FIG. 9a shows a logical correspondence between calibration data and an identity,

FIG. 9b shows another logical correspondence between calibration data and an identity,

FIG. 10 shows a third logical correspondence between calibration data and an identity, and

FIG. 11 shows comparison of an estimated cumulative distribution function with its reference function.

### DETAILED DESCRIPTION OF THE INVENTION

The invention relates to determining the authenticity of an article comprising a microchip package. Thus, the invention relates also to preventing counterfeiting articles comprising a microchip package. Examples of articles which comprise or may comprise a microchip package include
security documents, such as passports, bill notes, and identity cards,
RFID tags,
commercial articles comprising an RFID tag,
electronic keys, e.g. transponder keys,
smart cards, and
the microchip package.

A microchip package may consist of a microchip. Thus, the invention relates to determining the authenticity of articles comprising a microchip. In particular, the invention relates to determining the authenticity of a microchip package comprising the microchip itself.

Microchip package is understood in a broad sense. Therefore, an microchip package may
consist of a microchip,
comprise a microchip and a sensing element, or
comprise a microchip and a monitoring unit.

The microchip itself may comprise a sensing element and/or a monitoring unit, particularly in the case the microchip package consist of a microchip. The monitoring unit itself may comprise or be connected to a sensing element. When the microchip package comprises a microchip and a monitoring unit, the monitoring unit may be attached to the microchip. When the microchip package comprises a microchip and a sensing element, the sensing element may be attached to the microchip.

It has been noticed that a microchip package may comprise a sensing element that changes its output in response to the environment where the microchip package is located. The relation between the output and the environment may depend on the physical properties of the microchip and/or the sensing element. This property may be utilized in the invention in principle in two ways:
(1) The output of a sensing element of an authentic microchip package in a known environment must be in a known range. Thus, even if the digital identity of a first microchip is copied into a second microchip, the output of the sensing element of the second microchip is different from the output of the sensing element of the first microchip. Thus, given that the allowable range for the output of the sensing element of the first microchip in the environment is known, and the output of the sensing element of the second microchip does not fall into this range, the second microchip may be determined to be a forgery.
   or
(2) The output of a microchip package regarding the environment must match the actual environment. The relation between the output of a sensing element and the environment may be found out by calibration. Typically the physical properties of each microchip are unique, and therefore also the calibration is unique. Thus it has also been noticed that calibration information is unique to each microchip. Even if calibration information regarding a first microchip is copied to a second microchip, the second microchip does not function as designed, since the physical properties of the first and the second microchips are different due to manufacturing tolerances. Therefore, using the calibration information of the first microchip package to deduce a value of the environment with the second microchip package will result in incorrect values obtained with the second microchip package. It is also possible to compare the calibration information of the first microchip package with the calibration information of the second microchip package.

The microchip package comprised by the article of which authenticity is determined with the method, is assumed fully functional. The term “fully functional” here refers to a microchip package that functions as designed by the microchip package vendor or the forgery microchip package forger. The vendor may, on the other hand use the value of the measurable quantity in a known environment to determine the functionality of the device. Possibly only microchip packages that produce a value of a measurable quantity belonging to an acceptable range in an environment are considered fully functional by the vendor, and therefore sent to the market. On the other hand, a forger may produce a second microchip package, and consider it fully functional, if it functions as the forger has designed. However, the forger may not be able to modify the behavior of the microchip package, and he may not know a logical correspondence between the identity and calibration data, possible required by the vendor of the original microchip package.

The microchip package may communicate with a reader device using electrically conductive wires, or wirelessly, e.g. using radio frequency communication, optical communication, or acoustic communication. In a preferred embodiment, the microchip package communicates with a reader device using radio frequency communication. In a preferred embodiment, the microchip package is comprised in a radio frequency identification (RFID) transponder.

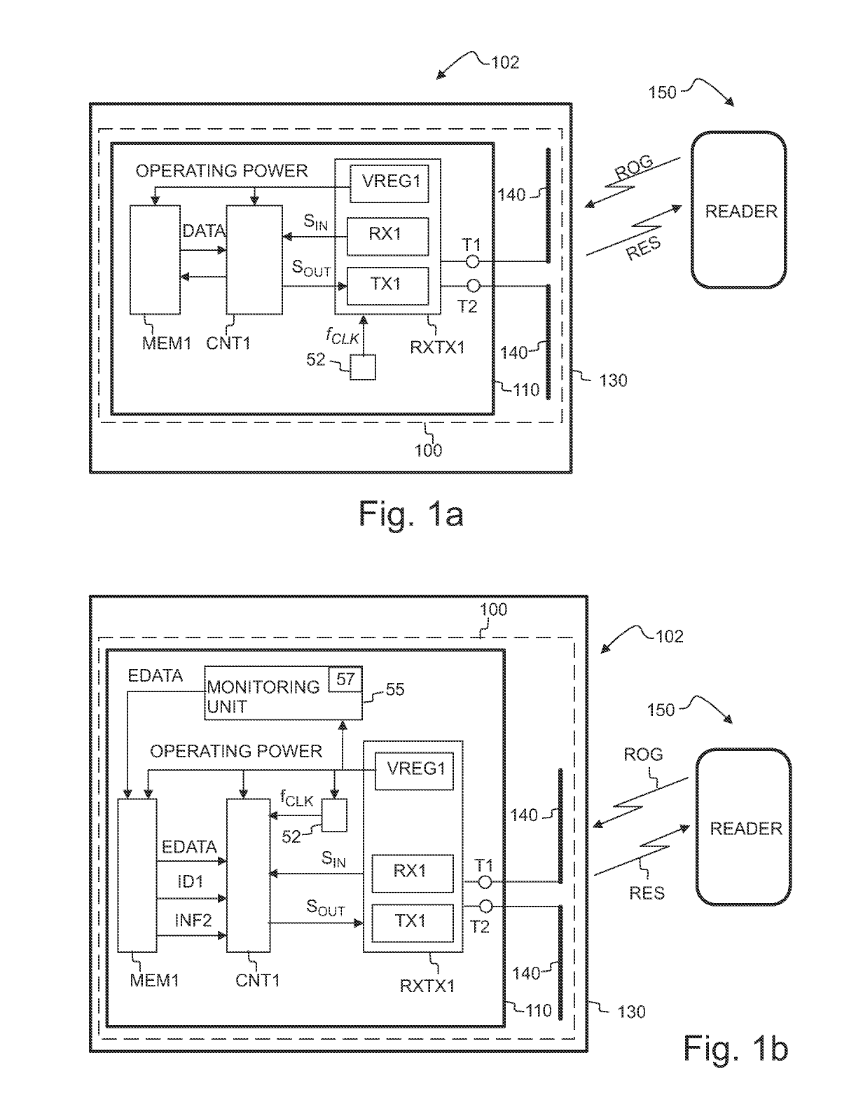

FIG. 1a shows an RFID communication system. The system comprises an RFID reader device 150 and an RFID tag 102. The RFID tag 102 comprises the microchip package 110. The microchip package 110 consists of a microchip. The microchip package 110 is bonded to an antenna 140 via terminals T1 and T2, whereby the microchip package 110 and the antenna 140 constitute an RFID transponder 100. The transponder 100 may be attached to a substrate 130 so as to form the RFID tag 102. The substrate 130 may be e.g. a plastic film, paper, or cardboard. The substrate 130 may constitute a document, whereby the tag may constitute a security document. The substrate 130 may be adhesive-lined so as to form an adhesive label. The transponder 100 may comprise protective layers to form a sealed structure. The transponder 100 may encapsulated so as to withstand various environmental conditions, e.g. moisture and/or other corrosive substances.

The transponder 100 may be arranged to send a response RES to an interrogation signal ROG. The interrogation signal ROG may be sent from a mobile reader 150 or a stationary reader 150. In particular, the mobile reader may be a portable reader.

Electromagnetic interrogation signal ROG transmitted in a wireless manner is converted into an electrical signal by the antenna elements 140. The chip 110 may comprise a radio frequency unit RXTX1, a control unit CNT1, and a memory MEM1. The radio frequency unit RXTX1 may comprise a signal receiver RX1, and a signal transmitter TX1. The receiver RX1 may also be called as a signal demodulator. The transmitter TX1 may also be called as a signal modulator. The radio frequency unit RXTX1 may also be called as an analog radio frequency interface. The radio frequency unit RXTX1 may comprise connection terminals T1, T2, which may be connected to at least one antenna element 140. The antenna elements may from e.g. a dipole antenna or an inductive antenna. The radio frequency unit RXTX1, the control unit CNT1, the memory MEM1, and a local oscillator 52 may be implemented on the same semiconductor chip 50.

The receiver RX1 may provide an input signal SIN based on the received interrogation signal ROG.

The control unit CNT1 may be arranged to enable transmission of first information ID1 e.g. when the input signal SIN contains a first (correct) password code (which matches with a reference code previously stored in the microchip package 110). The first information ID1 may comprise e.g. identification data of the transponder 100. The identification data ID1 may comprise e.g. an electronic item code (EPC) and/or the digital identity of the microchip package. A unique electronic item code assigned to an item may be stored in a transponder 100 as a binary number. The item code may refer to the item to which the transponder 100 is attached, while the digital identity of the microchip package refers to an electronic code unique to the microchip of the transponder 100.

Optionally, the control unit CNT1 may be arranged to enable transmission of second information INF2 e.g. when the input signal SIN contains a second (correct) password code (which matches with a reference code previously stored in the microchip package 110). The second information INF2 may comprise e.g. temperature history data, location data and/or calibration data. The second information INF2 may comprise a capability parameter, which specifies e.g.
whether the transponder is capable of monitoring temperatures and/or changes in temperature,
whether calibration data for the transponder exists,
calibration data, and/or
identification code for relevant calibration data.

The second information INF2 may be stored in the memory MEM1 of the transponder 100.

The response RES transmitted by the transponder 100 may comprise the first information ID1 and/or the second information INF2. The information ID1 and/or INF2 may be retrieved from the memory MEM1 by the control unit CNT1. The control unit CNT1 may send an output signal SOUT to the radio frequency unit RXTX1. The output signal SOUT may comprise the information INF2. The transmitter TX1 may generate the radio-frequency response RES based on the output signal SOUT. The input signal SIN and the output signal SOUT may be e.g. digital signals.

A dipole antenna may transmit information from the transponder 100 to a reader 150 by back scattering. Alternatively, an inductive antenna may be used. A coil antenna of the transponder 100 may cause modulation of the load for the reader 150. This modulation can be used for transmitting data from the transponder 100 to the reader 150.

In a preferred embodiment, the transponder 100 is substantially passive, i.e. the radio frequency unit RXTX1 is powered by energy extracted from an incoming radio frequency signal, i.e. the radio frequency unit RXTX1 operates without a battery. In this embodiment, the transponder 100 is powered e.g. by electro-magnetic energy transmitted from the reader 150. The combination of an antenna structure 140 and a radio frequency unit RXTX1 of a transponder 100 are arranged to provide operating power for the transponder 100 by extracting energy of an in-coming electromagnetic signal ROG. The radio frequency unit RXTX1 comprises a voltage supply VREG1, which is arranged to extract operating power from an incoming radio frequency signal. In particular, the voltage supply VREG1 may be arranged to extract operating power from the interrogation signal ROG. The operating power may be distributed to from the voltage supply VREG1 to the radio frequency unit RXTX1. Optionally, operating power may be distributed to from the voltage supply VREG1 to the control unit CNT1 and to the memory MEM1.

In this embodiment, the operating lifetime may be very long. Operating lifetime refers to a time when the transponder is capable of responding to an interrogation signal. In fact, the operating lifetime may be substantially infinite. There is no need to change a battery during the operating lifetime of the transponder. The transponder may be very small, as there it is not necessary to reserve a considerable space for the battery.

The transponder may be substantially passive, i.e. energy for operating the radio frequency unit RXTX1, the temperature monitoring unit 55, the control unit CNT1, the local oscillator 52, and the memory MEM1 may be extracted from a radio frequency field. Energy for operating the radio frequency unit RXTX1, the temperature monitoring unit 55, the control unit CNT1, the local oscillator 52, and the memory MEM1 may be extracted an interrogation signals ROG sent from a readers.

A passive transponder 100 may comprise a capacitor or a rechargeable battery for storing operating energy extracted from an interrogation signal ROG. Furthermore, an active transponder 100 may comprise a battery to supply power to the RFID transponder.

The local oscillator 52 generates a clock frequency f_{CLK}. The local oscillator 52 may be e.g. a ring oscillator. A ring oscillator may comprise e.g. a plurality of cascaded logical gates whose operating speed depends on the temperature. The local oscillator 52 may be e.g. a relaxation oscillator.

A carrier frequency of the response RES may be modulated at a modulation frequency f_{LF}. The modulation frequency f_{LF} may also be called as a “link frequency”. The modulation frequency f_{LF} of the response RES may, in turn, depend on the clock frequency f_{CLK} of the local oscillator 52.

It has been noticed that the frequency of such a local oscillator may depend on the temperature of the microchip package 110. Thus, also the modulation frequency f_{LF} may depend on the temperature of the microchip package 110. A change of the modulation frequency f_{LF} may indicate a change in the temperature. Consequently, the modulation frequency f_{LF} may be interpreted to be temperature data. Therefore, the local oscillator 52 may be considered a sensing element, the sensing element arranged to sense the temperature.

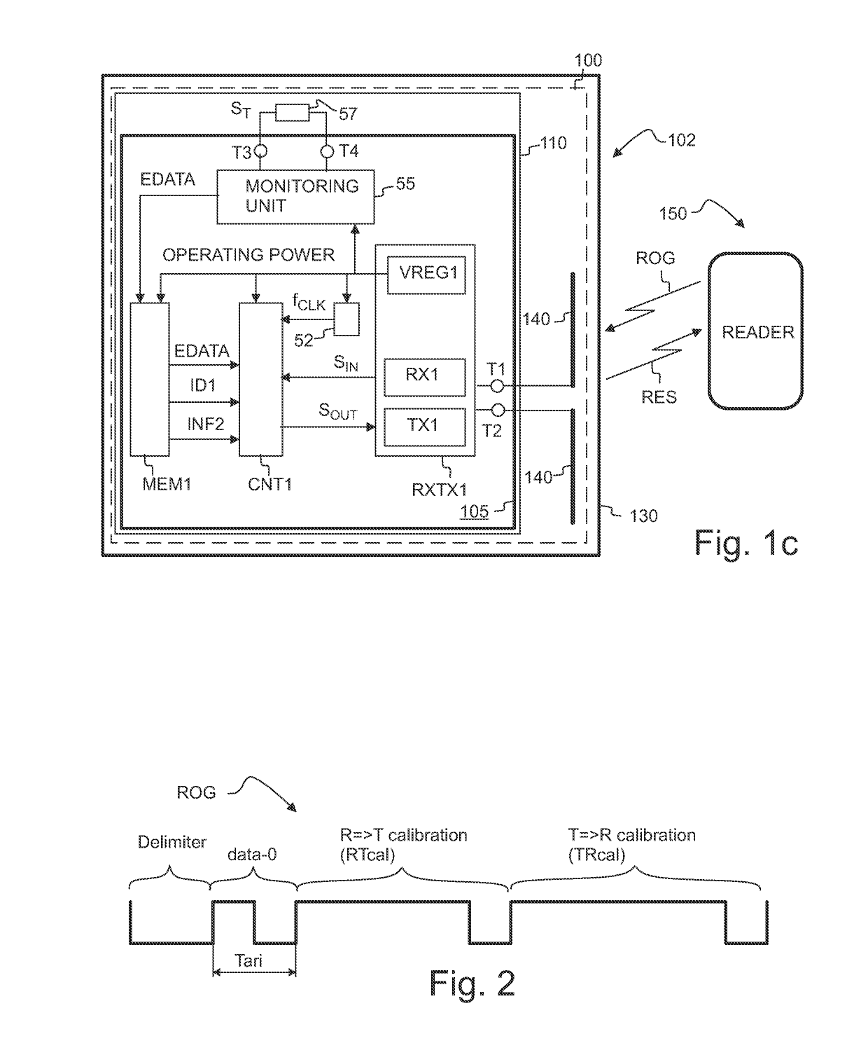

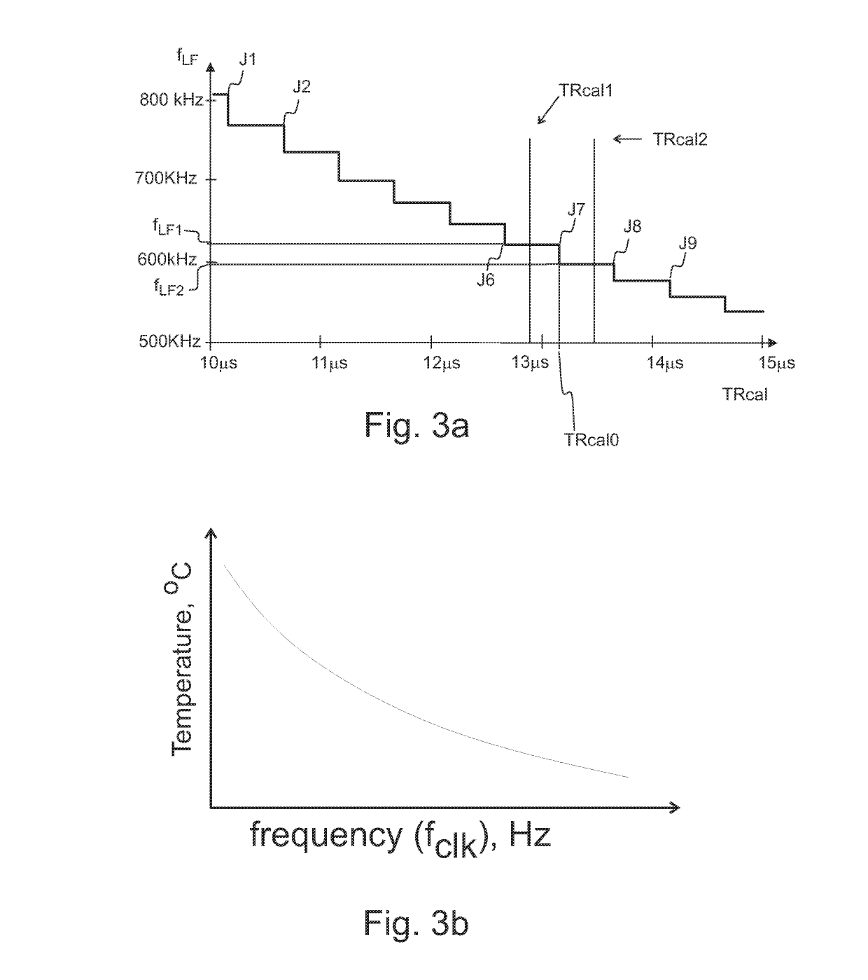

FIGS. 2, 3a, and 3b describe how temperature data can be obtained based on frequency of the local oscillator 52. Using the local oscillator as the sensing element is a widely applicable embodiment, since remote-access apparatuses complying with the EPC Gen 2 protocol comprise such an oscillator. However, as noted above, the remote access apparatus may comprise also other sensing elements, as will be discussed later.

Referring to FIG. 2, an interrogation signal ROG sent from a reader to a transponder 100 may comprise a frequency-setting parameter TRcal (reference is made to the EPC Gen2 protocol). The transponder 100 may be arranged to set a modulation frequency (“link frequency”) f_{LF} based on the value of the parameter TRcal. The value of the TRcal may be directly proportional to the temporal duration of the data sequence TRcal. The value of the parameter TRcal may be e.g. 50 μs.

The “Delimiter”, “data-0”, “Tari”, and “RTcal” may refer to other portions of the interrogation signal ROG, as defined in the EPC Gen2 protocol.

The transponder 100 may be arranged to set the modulation frequency f_{LF} according to the following equation:

$${f}_{LF} = \frac{D R}{Trcal}$$

The modulation frequency f_{LF} may also be called as a “backscatter link frequency”.

In practice, the transponder may be arranged to calculate the modulation frequency f_{LF} by using integer numbers as follows:

$${f}_{LF} = \frac{D R \cdot {f}_{CLK}}{ROUND ( TRcal \cdot {f}_{CLK} )}$$

where DR denotes a division ratio parameter. The value of the division ratio parameter DR may be e.g. 8 or 64/3. f_{CLK} denotes the frequency of the local oscillator 52. ROUND denotes a rounding or truncating function, i.e. it rounds or truncates an arbitrary number format to an integer number.

Referring to FIG. 3a, when the value of the frequency-setting parameter TRcal is increased, the modulation frequency f_{LF} may decrease in several (abrupt) jumps J1, J2, . . . , as can be derived from the equation. The modulation frequency f_{LF} may be substantially constant between TRcal values corresponding to two adjacent jumps J1, J2, provided that the clock frequency f_{CLK} is constant.

A first response modulated at the first frequency f_{LF1} may be provided by sending a first interrogation signal from a reader to the transponder 100 such that the first interrogation signal comprises a first frequency-setting parameter TRcal1. A second response from the same transponder 100 modulated at the second frequency f_{LF2} may be provided by sending a second interrogation signal from a reader to the transponder 100 such that the second interrogation signal comprises a second frequency-setting parameter TRcal2. By iteration, the TRcal1 and TRcal2 values may be selected such, that the first frequency f_{LF1} is different from the second frequency f_{LF2}, i.e. the frequency changes abruptly between TRcal1 and TRcal2. Moreover, to find out the TRcal value, where the frequency jump occurs, the difference between TRcal1 and TRcal2 may be iteratively decreased. A value of the TRcal variable, at which the frequency jump occurs, will be denoted by TRcal0, as depicted in FIG. 3a.

When the value of the frequency-setting parameter TRcal is varied by a small amount in the vicinity of a jump, i.e. the value TRcal0 of FIG. 3a, the clock frequency f_{CLK} being substantially constant, the modulation frequency f_{LF} may be abruptly changed from the value f_{LF1} to the value f_{LF2}.

It may be derived from the above equation that

$${f}_{CLK} = \frac{{f}_{LF 1} \cdot {f}_{LF 2}}{D R \cdot ( {f}_{LF 1} - {f}_{LF 2} )}$$

In other words, the clock frequency f_{CLK} may be calculated from the upper modulation frequency f_{LF1} and lower modulation frequency f_{LF1} associated with a single jump.

The time period between sending the first and second interrogation signals may be selected to be so short that the temperature of the local oscillator is not significantly changed during said time period.

Referring to FIG. 3b, the clock frequency f_{CLK} may depend on the temperature or other environment parameters. Vice versa, mathematically the temperature may be considered to depend on the clock frequency. However, the temperature as determined from the clock frequency depends on the accuracy of the measured frequency. In some systems, it may be difficult to measure the clock frequency accurately, as there may be some deviation in the backscattering frequencies f_{LF}.

Referring to FIG. 3c, the temperature changes the locations of the frequency jumps. The jumps number 1, 2, 7, 8, and 9 at the temperature T=0° C. are denoted by J1(0), J2(0), J7(0), J8(0), and J9(0), respectively. As the temperature is increased, e.g. to T=10° C., the pattern slightly changes. For example, the jumps may shift towards higher TRcal0 values, as depicted with J7(10). As the temperature is further increased, e.g. to T=60° C., it may happen that some jumps have the same corresponding TRcal0 values. Thus, it is possible that a TRcal0 value may correspond to several temperatures, depending on which TRcal0 value one is measuring. For example, the TRcal0 value corresponding to frequency jump number 8 at temperature 0° C., J8(0), could be the same as the TRcal0 corresponding to frequency jump number 7 at the temperature 60° C., J7(60). Therefore, the TRcal0 value may be used to determine the temperature, if a predetermined valid temperature range is given. In addition to the TRcal0 value, one may used the clock frequency to determine the temperature.

As discussed, both the clock frequency, f_{clk}, and the a frequency-setting parameter that matches with a jump, TRcal0, may be measured using a remote-access apparatus. In an embodiment, the clock frequency may be directly read from a remote-access apparatus using a reader device. In that embodiment, the remote-access apparatus comprises means for calculating the clock frequency and means for sending information indicative of the clock frequency. As these quantities are measurable, they will be called measurable quantities. For determining the temperature, the value a first measurable quantity, e.g. f_{clk}, or TRcal0, needs to be obtained, and calibration data may be used to calculate the value of the environment parameter, e.g. temperature, using the value of the measurable quantity.

In FIG. 1b, the microchip package 110 consists of a microchip. In FIG. 1b, the microchip package 110 (i.e. the microchip) comprises a monitoring unit 55. The monitoring unit further comprises a sensing element 57. The microchip package 110 of FIG. 1b is therefore designed for measurement purposes. The sensing element may be arranged to sense at least one environment parameter, such as temperature, pressure, or strain, humidity, brightness, strength of electromagnetic radiation, strength of the interrogation signal, or concentration of a chemical. The value of the environment parameter will be denoted by T. It is understood that T may refer to a value of any one of the environment parameters. The monitoring unit may monitor the value of more than one environment parameter.

The sensing element 57 may change the value of a measurable depending on the environment parameter. The measurable quantity may be e.g. a frequency, electrical resistance, capacitance, inductance, electrical conductance, an electric current, a voltage, or a time between two events. The value of the measurable quantity will be denoted by f. The monitoring unit may be arranged to measure multiple values of measurable quantities. For example, one value of a measurable quantity corresponding to one environment parameter. Or, as another example, several values of a measurable quantity corresponding to one environment parameter.

The monitoring unit 55 may send the value or values of the measurable quantity or quantities to the memory MEM as environment data EDATA. If calibrated, the monitoring unit 55 may send the value or values of the environment parameter or parameters to the memory MEM1 as environment data EDATA. The control unit CNT1 may receive the environment data from the memory, and communicate it to the radio frequency unit RXTX1. The radio frequency unit RXTX1 may further communicate this information with the reader device 150.

In particular, the monitoring unit may comprise oscillators, of which frequencies are dependent on the temperature of the microchip.

Referring to FIG. 1c, the microchip package 110 may comprise a microchip 105 and a sensing element 57. The microchip 105 comprises a monitoring unit 55 and terminals T3 and T4 electrically connected to the monitoring unit. The terminals T3 and T4 are arranged to be electrically connected to an external sensing element 57. In FIG. 1c, The terminals T3 and T4 are electrically connected to the external sensing element 57. The sensing element 57 may be arranged to sense at least one environment parameter, as discussed above. To use the sensing element, the sensing element is connected to the terminals. As the sensing element 57 is connected to the microchip 105, the microchip package 110 comprises the sensing element 57.

The microchip package may comprise
a microchip 110 comprising a sensing element (FIGS. 1a and 1b) or
a microchip 110 and a sensing element 57 (FIG. 1c).

It is noted that an oscillator may be considered a sensing element, if the frequency of the oscillator depends on the environment. To be usable as a sensing element, an output of the sensing element has to be measurable. Some possibilities were discussed above.

Referring to FIG. 3d, the value of the output of the sensing element, i.e. the value of the measurable quantity, depends on the value of the environment parameter. In FIG. 3d, temperature is considered as the environment parameter, but also other environment parameters can be measured with sensing elements, as discussed above. The measurable quantity, i.e. the quantity that changes with the environment parameter, may be e.g. frequency, TRcal0, resistivity (e.g. of a thermistor or a piezoresistor), or voltage (e.g. of a thermocouple or a piezoelectric sensing element). Also other measurable quantities are possible, as discussed above, depending on the sensing element used. E.g. capacitive and inductive sensing elements are also common.

The dependence of the measurable quantity on the environment parameter, or dependence of the environment parameter on the measurable quantity may be found out by calibration. For practical reasons, the dependence of the environment parameter on the measurable quantity is often more preferably.

Calibration may be done with well known curve fitting algorithms. Typically calibration measurements are performed, and some curve, i.e. a function, is fitted to the calibration measurement data. For example, a number of pairs (f′ᵢ;T′ᵢ) may be measured in the calibration measurements, where f′ᵢ is the value of the value of the measured quantity in ith measurement, and T′ᵢ is the reference value of the environment variable in ith measurement. It should be emphasized, that T′ᵢ is the value of the environment variable in the remote-access device, with which the measured quantity is measured. For example, T′ᵢ may be the temperature of the remote-access device, which in a stationary state equals the ambient temperature. For calibration, a function h may be used to interpolate or extrapolate the relation between these values as T(f)=h(f) and, since one generally wants this function to represent the calibration measurements, it is required that h(f′ᵢ)≈Tᵢ for all i. The function h(f) may be a polynomial, or some other suitable function. Typically, a function with only a few parameters is used, such a first degree polynomial, and the parameters are estimated with well known curve fitting techniques. Explicit examples are the first and second degree polynomials: h(f)=b₁f+b₀ or h(f)=b₂f²+b₁f+b₀. It is also possible, that all the measured values (f′ᵢ;T′ᵢ), possibly arranged according to increasing f′ᵢ, form a lookup table that is used as h. Similarly, a function g describing the relation f(T)=g(T) could be used. If needed, the environment parameter needs to be solved from the functional relation, provided that a measured f′ is known. However, for purposes of authentication, coefficients of the function g are as applicable as the coefficients of h.

Calibration data means data that can be used to determine the value of the environmental variable T based on the measurement of a quantity f. It is also noted, that by using higher than 1^{st} degree polynomials g or h, the value of the environment variable can be more accurately determined than with a 1^{st} degree polynomial. Moreover, it is noted, that in case higher degree polynomials are used, it is feasible to used the function h rather than g, since this allows for direct solution of the value of the environment variable. In case a higher degree g was used, one would have to solve the roots of the polynomial, and choose the correct one to determine the value. In particular, the calibration data may comprise the coefficients b₀ and b₁. When applicable, the calibration data may comprise other coefficients, such as the coefficient b₂.

Calibration data may also be divided to a general part and a corrective part. In case a set of remote apparatuses is calibrated, it is possible to form calibration data such that part of the calibration data concerns a set of remote-access apparatuses and part of the data concerns the individual apparatus. For example if the calibration measurements are be done for a set of remote-access apparatuses, the calibration data thus obtained will be applicable to the set of remote access apparatuses. However, calibration data may also comprise correction terms for individual remote-access apparatuses. For example, the coefficients of the first degree polynomial, b₀ and b₁, may be approximately the same for all remote-access apparatuses having a microchip of the same family. Thus the same coefficients, b₀ and b₁, may used for all remote-access apparatuses having a microchip of the same family, but in addition, calibration data may comprise a correction term b′₀ indicative of the offset of the individual remote-access apparatus in relation to the set of apparatuses. Thus, for example, the temperature for an individual remote-access apparatus could be determined as T′=b₁f′+b₀+b′₀. Here only the correction term b′₀ needs to be known for each individual remote-access apparatus, while the coefficients b₁ and b₀ may be found from calibration measurements of a set of remote-access apparatuses, and are therefore applicable to a set of remote access apparatuses. This allows, for example, a remote-access apparatus to contain information indicative of the correction term, and a reader device to contain information of the other coefficients. In addition, a correction term b′₁ for the slope may be used, in which case the temperature would be calculated as T′=(b₁+b′₁)f′+b₀+b′₀.

As discussed, the calibration data may be divided to at least two parts. The parts may be stored on different storage devices. Therefore, the memory requirements for the remote-access apparatus are relatively small. Moreover, some typical values for the correction term may be coded in a table so that these values can be pointed with a piece of data that is stored in the tag. The tag may, as an example, contain a 8-bit integer, which is indicative of the value of the correction term. The reader device can then deduce the coefficient based on the RFID chip family, and obtain a value for the constant from a table using this 8-bit integer. Naturally, also for the coefficient b₁ or other coefficients, a correction term can be stored instead of the actual data.

For statistical reasons the correction terms, e.g. b′₀ or b′₁, of the calibration data typically normally distributed. This may be utilized in the numbering of the microchip packages such that there is a logical connection between the calibration data and the identity of the microchip package. For statistical reasons the correction terms may have zero mean. Therefore, on the average half of the correction terms may be negative, while half of the correction terms may be positive.

It has been noticed that the dependence of the measurable quantity on the environment parameter rests on the physical properties of the microchip package. A forgery microchip package may therefore be recognized from at least one of the following
having incorrect values for the measurable quantities in a given environment,
when applying calibration data, producing incorrect values for the environment parameter,
producing correct values for the environment parameter, but having incorrect calibration data comprised in the microchip package, and
calibration data is not consistent with the identity of the microchip package.

It is in principle possible to prevent the third type of forgery microchip packages from being produced by using cryptography. For example, the correct calibration data can be encoded with the vendor's private key before storing the encoded calibration data to the microchip package. When using the calibration data, the data is decoded with the vendor's public key. Reference is made to public key cryptography commonly used in secure communication. However, this scheme requires that the vendor's public key is known by the reader device. The public key can be stored in the memory of the microchip package, it can be stored in a reader device, or it may be stored in an external server. However, some microchip packages comprise only a small amount of memory, and therefore the public key cannot always be stored on the microchip package. Moreover, if the public key is stored in the reader device or in an external server, the flexibility of the system is more limited, as all the data needed for measurements is not comprised in the microchip package.

It is also possibly that the identity of the microchip package comprises a checksum indicating that the identity is an allowable identity. Therefore, all microchip packages having an identity with an erroneous checksum may be considered forgery. Checksums and their use are well known e.g. in the field of bank transactions. However, the use checksums does not prevent copying an identity of a microchip, it only makes harder to number blank microchip packages. A blank microchip package here refers to a microchip package, of which identity can, but has not been, written to its memory.

According to the invention, the dependence of the measurable quantity on the environment parameter can be used to authenticate the microchip package. The microchip package can be authenticated by several embodiments of a method

(a)
receiving a value/values of a measurable quantity/quantities in a known environment, and
comparing the value/values of the measurable quantity/quantities with reference value/values for the measurable quantity/quantities corresponding to the known environment; to determine the authenticity of the microchip package.
   (b)
receiving first value/values of a measurable quantity/quantities in a first environment,
receiving second value/values of a measurable quantity/quantities in a second environment,
comparing the first value/values of the measurable quantity/quantities with reference value/values for the measurable quantity/quantities corresponding to the first environment, and
comparing the second value/values of the measurable quantity/quantities with reference value/values for the measurable quantity/quantities corresponding to the second environment; to determine the authenticity of the microchip package.
   (c)
receiving a value/values of a measurable quantity/quantities in an environment,
using calibration data and the value/values of the measurable quantity/quantities to calculate the value/values of an environment parameter/parameters,
receiving a reference value/values for the environment parameter/parameters, and
comparing the calculated value/values of the environment parameter with the reference value/values for the environment parameter/parameters; to determine the authenticity of the microchip package.
   (d)
receiving calibration data for the microchip package,
receiving an identity of the microchip package,
using the identity to obtain reference for the calibration data for the microchip package, and
comparing the calibration data with the reference for the calibration data; to determine the authenticity of the microchip package.
   (e)
receiving calibration data or a value of a measurable quantity in a known environment for the microchip package,
receiving an identity of the microchip package,
using (ia) the calibration data or (ib) the value of a measurable quantity in a known environment and (ii) the identity, determining a truth-value of a logical correspondence between the calibration data and the identity, and
determining the authenticity of the microchip package using the truth-value.

According to another aspect of the invention, the dependence can be used to authenticate a set of microchip packages. When a set of microchip packages is authenticated, each microchip package of the set is authenticated. Therefore, set of articles comprises the article of which authenticity is determined. A set of microchip package can be authenticated by the embodiments:

(f)
receiving calibration data or values of a measurable quantity in a known environment for the set of microchip package,
receiving identities of the microchip packages,
using (ia) the calibration data or (ib) the values of a measurable quantity in a known environment and (ii) the identities, determining truth-values of a logical correspondence between the calibration data and the identity,
comparing the proportion of “true” truth-value to a predetermined ratio and
determine the authenticity of the set of microchip packages by comparing the proportion of “true” truth-values to a predetermined ratio.
   (g)
receiving calibration data for the set of microchip packages,
receiving a reference distribution function of calibration data, and
using the reference distribution function and the calibration data for the set of microchip packages; to determine the authenticity of the set of the microchip packages.
   (h)
receiving at least one value of at least one measurable quantity for each microchip package in the set of microchip packages,
receiving at least one reference distribution function for the values of the measurable quantities, and
using the reference distribution function and the values of the measurable quantities; to determine the authenticity of the set of the microchip packages.

These embodiments will be described in more detail below.

In the above methods, at least one of
reference value/values of the measurable quantity/quantities,
calibration data,
reference calibration data,
basis for determining a truth-value of a logical correspondence,
reference functional relation between (i) the package identities and (iia) the calibration data or (iib) the value of a measurable quantity in a known environment,
reference density function for calibration data,
a statistical measure of a reference density function for calibration data,
reference density function for values of a measurable quantity, and
a statistical measure of a reference density function for values of a measurable quantity
   may be obtained from a database. The database comprises the corresponding information. In addition, the database may comprise the identity of the microchip package, and the other information related to a microchip package or to a set of microchip packages may be comprised in the database in association with the identity. The database may be accessed with the identity of the remote access apparatus. It is noted that a reference value for the measurable quantity is dependent on the environment. Therefore, the database may also be accessed with a reference value for an environmental parameter.

In all the embodiments, where the value of the measurable quantity is received, the value can be measured using a remote-access apparatus. However, the value may also be received over an interface. The interface may be arranged to communicate with a database. As an example, a computer program may obtain the information over the interface.

The database may be stored in the remote access device, or it may be stored in another remote access device. Furthermore, the database may be stored in the RFID reader device, in a detachable memory card used in connection with the reader device, in an external server, or the data may be stored partly in some or all of the previous, including the remote access apparatuses. For example, a calibration correction term may be stored on the remote-access apparatus, while the other calibration data may be stored in the reader device, or in a server arranged to communicate with the reader device.

The database can also be distributed. For example a part of the database can be stored in an external database, a part in a remote access apparatus, and a part in the reader device. Furthermore, the database can be distributed to several remote access apparatuses. In case the data is stored to the remote-access apparatus that is used for measurements, the identity of the remote-access apparatus is not necessarily needed to obtain data from the database.

The database can be made accessible for a user only with an access code. Thus, only authorized users may have access to the database. The access code may be indicative of the access type: The database user may have full access, i.e. read and write access, to the database, a user may have full read access to the database.

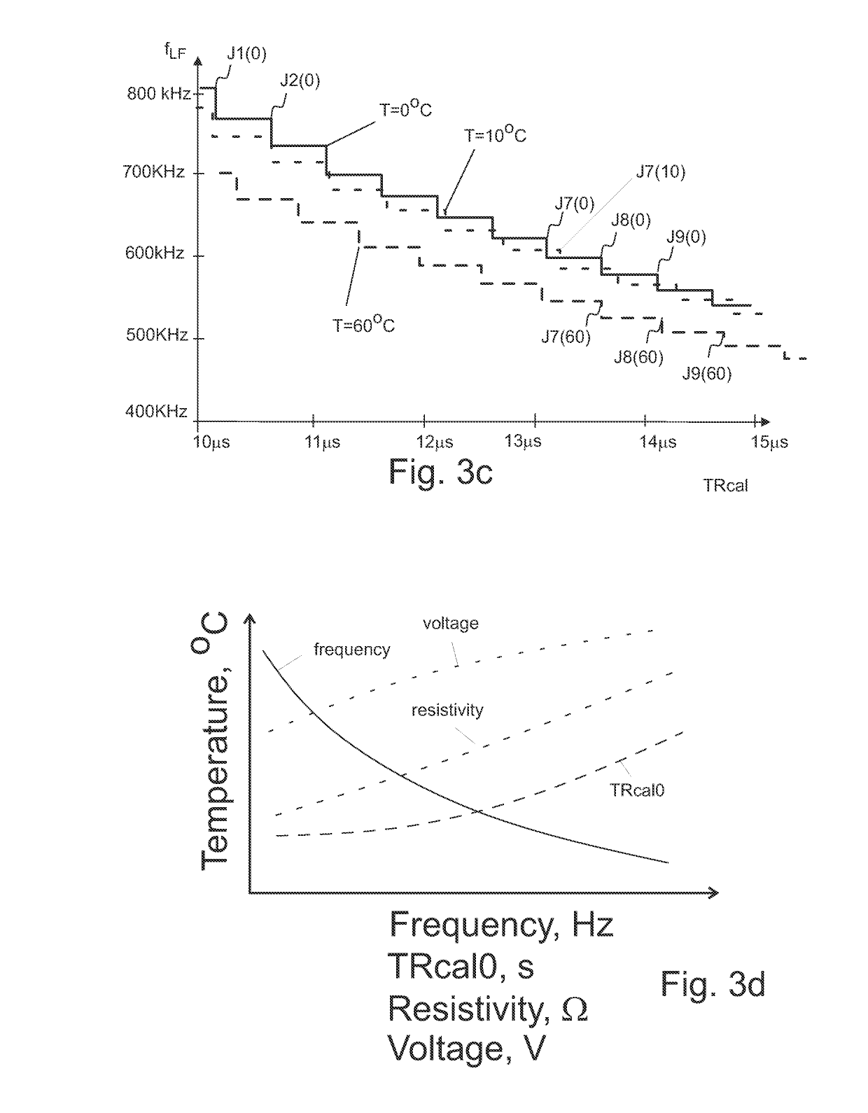

In the embodiment (a), a value of a measurable quantity is measured in a known environment using the microchip package. A flowchart of the process is shown in FIG. 4. The known environment refers to a known value of the environment parameter, e.g. temperature. The known environment may be e.g. “room temperature”. FIG. 4 shows an embodiment where the authenticity of the microchip package is determined in a reader device. In another embodiment, the authenticity is determined in a computer receiving the needed information from a reader device and/or from a database.

The value of the environment parameter is requested 410a by the reader device from a sensor. The sensor may receive the request and provide 415 the reader device with the value of the environment parameter. The reader device receives 410b the value of the environment parameter.

The reader device requests 420a and receives 420b at least one value of at least one measurable quantity. The device comprising the microchip package measures the requested value/values of the measurable quantity/quantities and provides 425 the reader device with the value/values.

It is understood, that the value(s) is/are first requested by a reader device, then, after receiving the request, provided by another device, and after that received by the reader device. All the values may be requested at substantially the same time, provided at substantially the same time, and received at substantially the same time, or each value may be individually requested, provided, and received. This applies to all the request-provide-receive-sequences described in the FIGS. 4-8. It is also understood that the expressions singular/plural and singular(s) refer to one or many, i.e. at least one. Examples are “value(s)” and “quantity/quantities” referring to at least one value or quantity, respectively.

The reader device requests 430a and receives 430b the identity of the microchip package. The device comprising the microchip package provides 435 the reader device with the identity. The reader device requests 440a and receives 440b at least one reference value for the measurable quantity, at least one reference value corresponding to each measurable quantity, using the identity of the microchip. A database provides 445 the reader device with the at least one value. The database may also provide the reader device with multiple reference values, whereby the reader device may determine the at least one reference value using the multiple reference values. The reader device may determine one reference value for each value of the measurable quantity/quantities using the multiple reference values.

It is also understood, that the reference value(s) may be obtained before the value(s) of the measurable quantity/quantities. Therefore, the steps 420a, 420b and 425 may be performed after the steps 440a, 440b and 445.

By comparing 450 the measured value(s) of the measurable quantity(-ies) with the reference value(s) for the measurable quantity(-ies), the authenticity of the microchip package may be determined. If the difference between the measured value and the reference value is below a tolerance value, the microchip package may be determined to be authentic. In contrast, if the difference exceeds a limit, the microchip may be determined to be a forgery.

It is also possible that the sensing element of the microchip package may output several values of the measurable quantity in the known environment. For example, if the TRcal0 value are used as the measurable quantity, several different TRcal0 values correspond to a known temperature. In addition, the microchip package may comprise several sensing elements, e.g. several oscillators. Each sensing element may output a value of a measurable quantity indicative of the value of the environment parameter. Thus, for example a multiple of frequencies may be compared with a multiple of reference frequencies. In case all the frequencies match their reference values, the microchip package may be determined authentic. The microchip package may be determined authentic also if at least one of the frequencies match its/their reference value(s).

The reference value for the measurable quantity may be stored in a database, and the database may be stored e.g. in the microchip package, in a memory card or in an external database. However, if the microchip package is used to store the reference value(s) for the measurable quantity(-ies), it is possible to modify these values based on measurements. The database may comprise reference values corresponding to different environments (e.g. temperatures). The reader device may request the database from the microchip package, and perform the comparison. The database may be also be stored in the reader device. In this case, the reference values are stored in the database association with the identity of the genuine microchip. The reference values are retrieved from the database using the identity of the tested microchip.

It is also possibly to compare the database itself with a reference database. E.g. a first database comprising reference values for the measurable quantity may be stored in the microchip package, and a second database comprising reference values for the measurable quantity may be provided by the microchip vendor. In this case, the database themselves may be compared with each other. Alternatively, or in addition, the database as provided by the microchip package vendor should be used for receiving the reference value(s) for the measurable quantity(-ies).

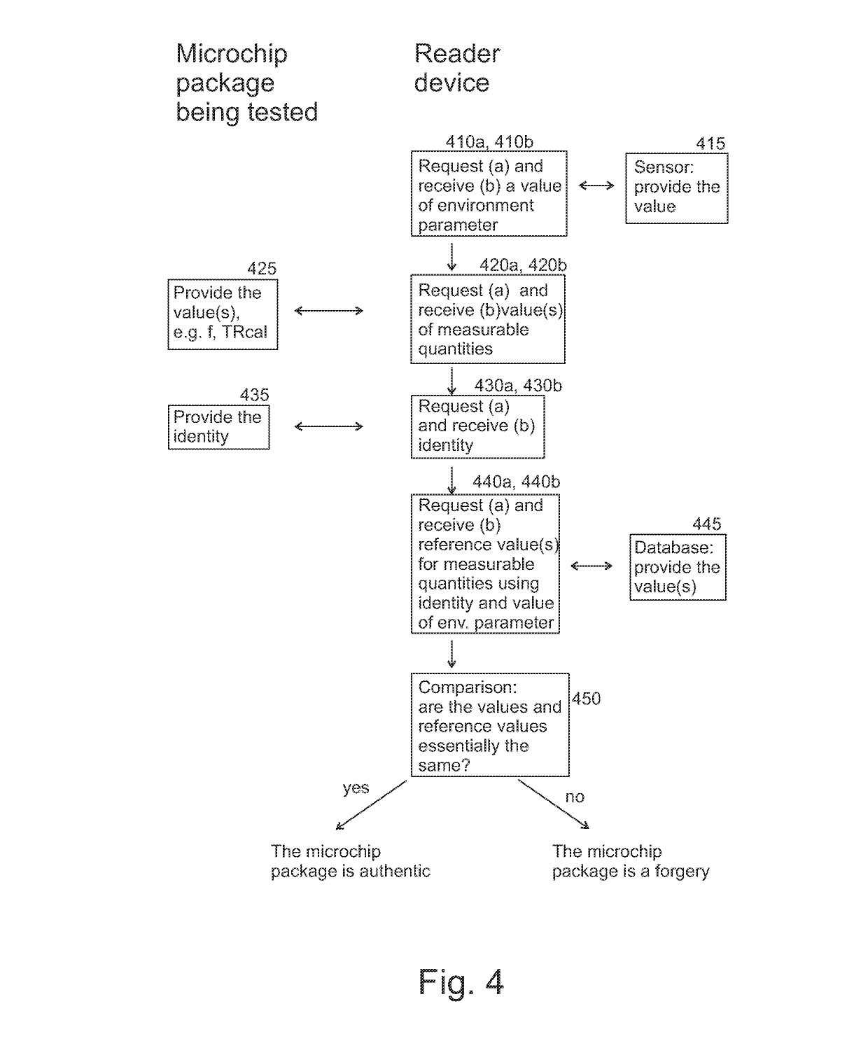

The vendor of the authentic microchip packages produces the database used for receiving the reference information. Alternatively, a vendor of devices comprising the authentic microchip packages produces the database used for receiving the reference information. The process for producing the database is shown in FIG. 5. As previously, in the embodiment of FIG. 5, the reader device is used to produce the database. However, the essential values may be requested from a reader device by another device, e.g. computer, and the another device may produce the database.

The system used to produce the database may comprise a control unit, such as an environment chamber, to control the environment in which the authentic microchip package is located. The control unit may set 505 the value of the environment parameter, e.g. set a temperature in which the microchip package is located. The system may comprise several control units, which may change several environment parameters. E.g. a chamber may be used to change the temperature of the microchip, and a reader device may be used to change the intensity of electromagnetic radiation, e.g. signal strength. The environment may be characterized by the two parameters: temperature and signal strength. The reader device may request and receive 510 the value(s) of the environment parameter(s). A sensor or sensors may provide 515 the reader device with the value(s). The sensor(s) may be arranged in the control unit, and the control unit may provide the reader device with the value(s).

The reader device requests and receives 520 at least one value of a measurable quantity. The authentic microchip package provides 525 the reader device with the value(s). In the figure, the authentic device refers to a device comprising the authentic microchip package. The at least one value may be obtained from a sensing element. E.g. a clock frequency or multiple TRcal0 values may be obtained from a microchip comprising a local oscillator. As another example, multiple frequencies may be obtained from a microchip comprising multiple oscillators.

The reader device requests and receives 530 an identity of the authentic microchip package. The authentic microchip package provides 535 the reader device with the identity. The reader device send the identity, the value of the environment parameter and the value(s) of the measurable quantity(-ies) to a database. The database stores 545 the value. The reader device determines 550 whether enough points are measured or not. If not, the control unit changes the value of the environment parameter, and the reader device performs the measurements again. If yes, the database has been produced for the microchip package. The database may comprise information on several microchip packages.

It is noted that the described three steps
request, provide 515 and receive 510 a value of an environment parameter,
request, provide 525 and receive 520 value(s) of an environment parameter, and
request, provide 535 and receive 530 value(s) of an environment parameter
   may be performed in any order. It is also possible that the database is accessed with the identity, and the values of measurable quantities and environment parameters are sent to the database at different times.

In the embodiment (b), values of a measurable quantities are measured in at least a first and a second environment using the microchip package. First environment may correspond to a first temperature and the second environment may correspond to a second temperature. At least one value of a measurable quantity is measured in the first environment and at least one value of the measurable quantity is measured in the second environment. Reference values corresponding to the first environment may be obtained as discussed in the context of embodiment (a). Reference values corresponding to the second environment may be obtained as discussed in the context of embodiment (a). Values of the measurable quantity(-ies) are compared with its/their reference value(s), and the authenticity of the microchip package is determined based on the comparison. This embodiment may provide a more reliable authentication, as values in several environments are used.

A particularly attracting embodiment is the case, where the first environment is characterized by a temperature and an electromagnetic signal strength, in particular, the signal strength of the interrogation signal, and the second environment is characterized by the same temperature and another electromagnetic signal strength, in particular, another signal strength of the interrogation signal. Thus, by changing the signal strength of the reader device, multiple environments may be rapidly generated and used in the authentication of the microchip package.

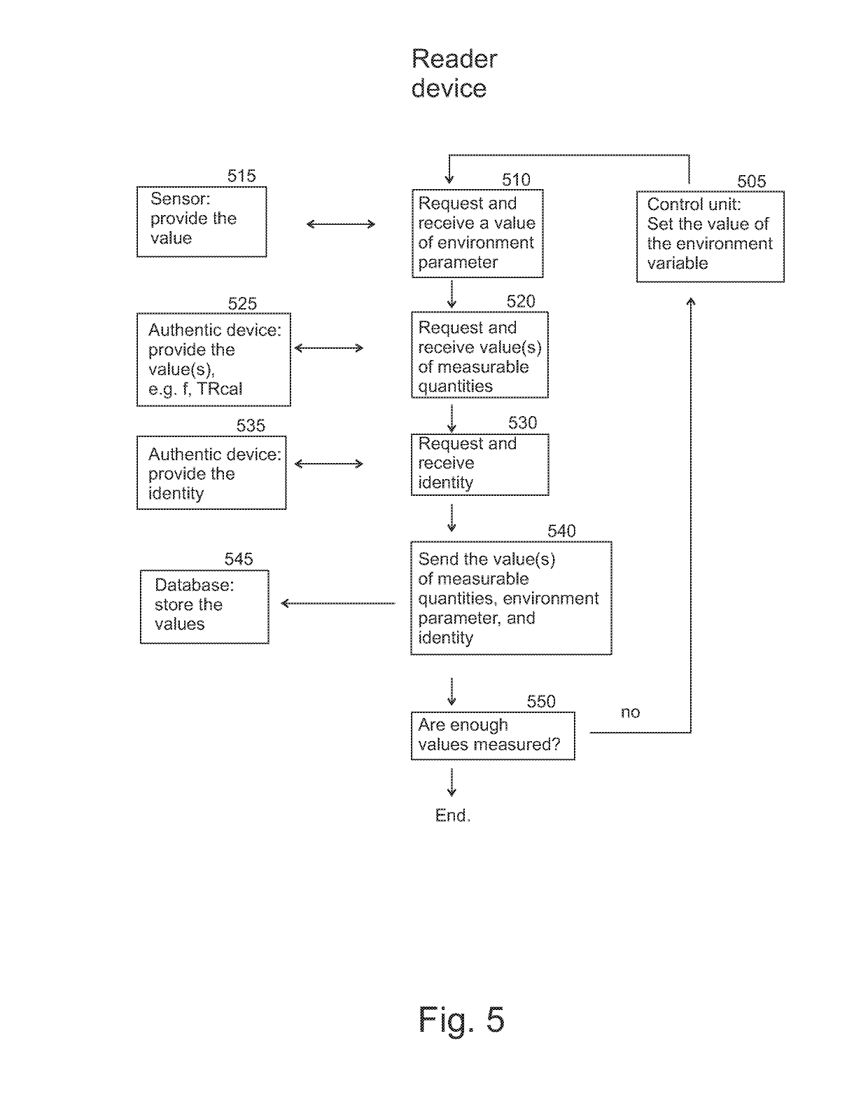

This embodiment is shown in FIG. 6. A first value for the environment parameter (i.e. signal strength) is set 610 at the reader device. Using this signal strength, the reader device requests and receives 612 at least one value of at least one measurable quantity. The device comprising the microchip package measures the requested values of the measurable quantity on provides 614 the reader device with the values.

A second value for the environment parameter (i.e. signal strength) is set 620 at the reader device. Using this signal strength, the reader device requests and receives 622 at least one value of at least one measurable quantity. The device comprising the microchip package measures the requested values of the measurable quantity on provides 624 the reader device with the values.

The identity is requested, obtained and used as discussed in the context of FIG. 4. Furthermore, the values of the measurable quantities are compared with their reference values as discussed in the context of FIG. 4. It is noted that the database, as generated as discussed in FIG. 5, may comprise reference values for the measurable quantities in several environments. The embodiment (b) may also be carried out in a computer receiving the needed information from the reader and/or a database.

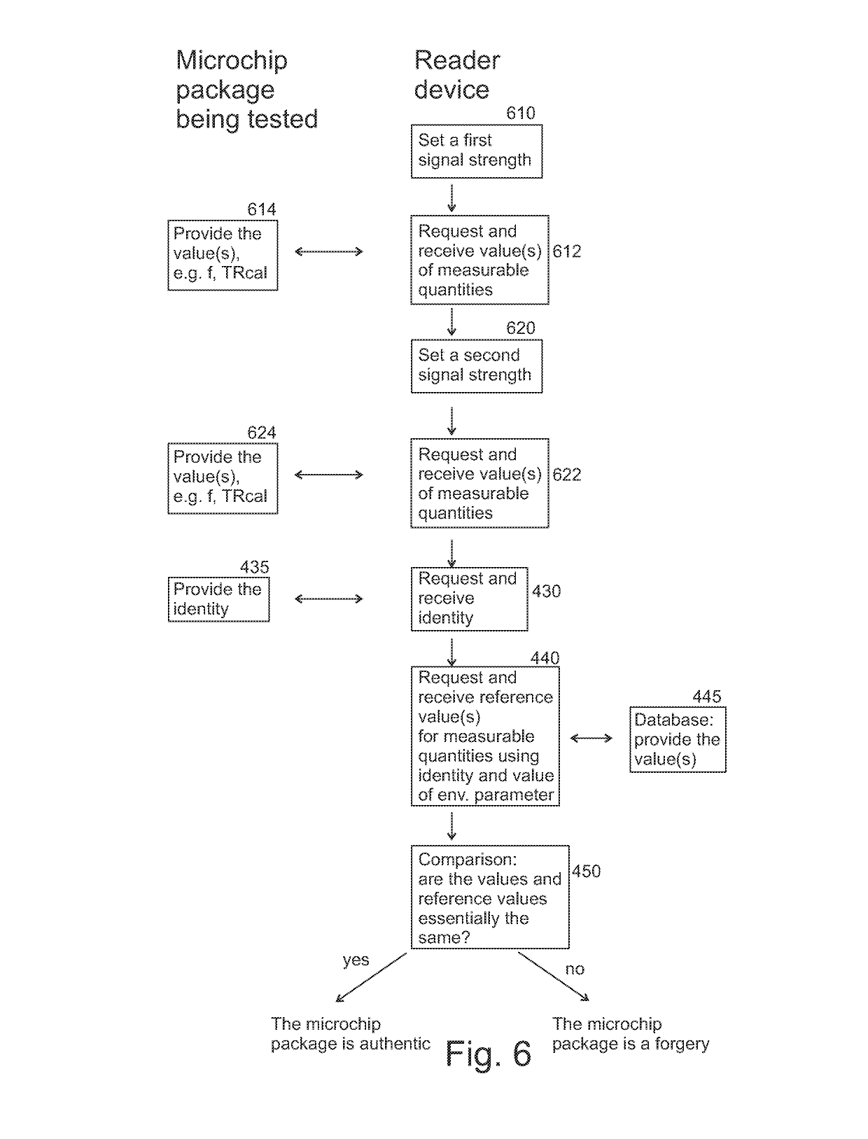

The embodiment (c) differs from the embodiment (a) in that calibration data is requested, received and used to convert the value(s) of the measurable quantity(-ies) to the value(s) of environment parameter(s). The embodiment is shown in FIG. 7 as a flow chart. Also FIG. 7 shows an embodiment where the authenticity of the microchip package is determined in a reader device. In another embodiment, the authenticity is determined in a computer receiving the needed information from the reader and/or a database.

The value of the environment parameter may be measured 710 using a sensor. The sensor may provide 715 the reader device with the value of the environment parameter. The reader device requests and receives 720 at least one value of at least one measurable quantity. The device comprising the microchip package measures the requested value(s) of the measurable quantity(-ies) and provides 725 the reader device with the value(s).

Calibration data of the microchip package may be stored in the microchip package itself. In that case calibration data may be requested from a database (the database being located in the microchip's memory) without information on the microchip package's identity. However, other databases may be accessed with the identity of the microchip package.

The reader device may optionally (as discussed above) request and receive 730 the identity of the microchip package. The device comprising the microchip package may optionally provide 735 the reader device with the identity.

The reader device requests and receives 740 calibration data for the microchip package from a database. The identity of the microchip package may optionally be used to access the database. A database provides 745 the reader device with the calibration data. The reader device calculates 750 a value(s) for the environment parameter(s) using the value(s) of the measurable quantity(-ies) and calibration data.

It is noted that the three steps
request, provide 715, and receive 710 a value of the environment parameter,
request, provide 725, and receive 720 value(s) of measurable quantity(-ies), and
request, provide 745, and receive 740 calibration data
   may be performed in any order.

By comparing 755 the measured value(s) of the environment parameter(s) with the calculated value of the environment parameter(s), the authenticity of the microchip package may be determined. The reference value(s) for environment parameter(s) may, alternatively to being measured, be obtained over an interface. If the difference between the reference value and the calculated value is below a tolerance value, the microchip package may be determined to be authentic. In contrast, if the difference exceeds a limit, the microchip may be determined to be a forgery.

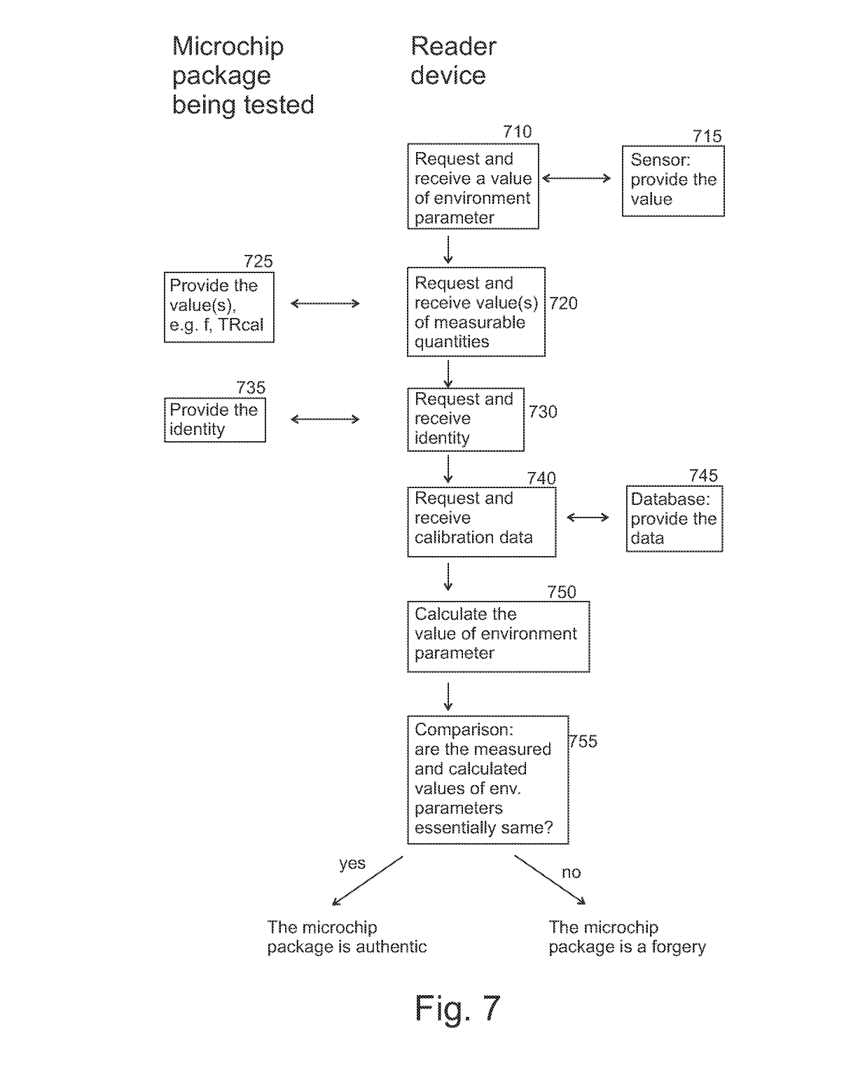

The embodiment (d) differs from the embodiments (a) and (c) in that a first calibration data comprised in the microchip package is compared to a second calibration data comprised in another database to determine the authenticity of the microchip package. In addition, the capability of measuring the environment parameter accurately is tested, as in the embodiment (c). The capability of measuring the environment parameter accurately may be tested before comparing the first calibration data with the second calibration data, or it may be tested after comparing the first calibration data with the second calibration data. In FIG. 8, the first calibration data is compared with the second calibration data before testing the capability of the microchip package for measuring the environment parameter accurately.

In the embodiment (d), the reader device requests and receives 810 first calibration data of a microchip package. The device comprising the microchip package provides 815 the reader device with the first calibration data. The reader device requests and receives 820 an identity of the microchip package. The device comprising the microchip package provides 825 the reader device with the identity. The reader device requests and receives 830 second calibration data of a microchip package from a database using the identity. The database provides 835 the reader device with the second calibration data. The reader device compares the first calibration data with the second calibration data. In case the calibration data are different, the microchip package can be considered fraudulent.

The steps 810, 820, and 830 may be performed also in a different order, however, the identity may have to be received 820 before requesting the second calibration data 830 from a database.

In case the calibration data are essentially or exactly the same, the microchip package may be considered authentic only if it can be used to accurately measure the value of the environment parameter by using the calibration data. As the first and the second calibration data are essentially the same, it does not matter which calibration data is used in the measurements.

In case the calibration data are essentially or exactly the same, the reader device requests and receives 850 a value/values of an environment parameter/parameters. A sensor or an interface provides 855 the reader device with the value(s). The reader device requests and receives 860 a value or values of at least one measurable quantity. The microchip package provides 865 the reader device with the value(s). The reader device calculates 870 the value(s) of the environment parameter(s) using the first or the second calibration data. The reader device compares the reference value(s) for the environment parameter(s) with the calculated environment parameter value(s) to determine the authenticity of the microchip package.

It is also possibly to first determine whether the microchip package can be used for accurate measurements (embodiment (c), steps 850-880) and later compare the first and the second calibration data with each other (steps 810-840).

FIG. 8 shows an embodiment where the authenticity of the microchip package is determined in a reader device. In another embodiment, the authenticity is determined in a computer receiving the needed information from the reader and/or a database.

The embodiment (e) is fundamentally different in that a value of a measurable quantity is not needed at all. However, as will be discussed, the embodiment can be applied also in addition to any of the previous embodiments. The method relies on the idea that the microchip package vendor knows a logical relation between the identity of the microchip package and calibration data (or a value of a measurable quantity, as will be discussed later). The microchip package vendor may set the digital identity of each microchip package, which identity generally is a natural number, such that the identity determines a property of the calibration data.

For example, as discussed above, a correction term may be used in the calibration such that coefficients of a function are obtained when a correction factor is added to general calibration data, wherein the general calibration data is applicable to a set of microchip packages. It is known from general data fitting procedure, that the correction term will be at least approximately normally distributed with zero mean.

Now, the microchip package vendor may assign an odd identity of the form 2N+1, where N is an integer (at least zero), to a microchip package, of which calibration data comprises a correction factor less than or equal to zero. Similarly, the microchip package vendor may assign an even identity of the form 2N (or 2N+2; depending on the smallest identity number), where N is an integer (at least zero), to a microchip package, of which calibration data comprises a correction factor greater than zero. Thus, by comparing the calibration correction factor and the microchip package identity, a fraudulent package can be determined whenever the logical correspondence is violated, e.g. a package with an odd identity comprises calibration data, wherein a correction factor is greater than zero. A truth-value may thus be determined, the truth-value being indicative of whether a logical correspondence between the calibration data and the identity has been violated or not. Alternatively to calibration data, a value of the measurable quantity, possibly in a predefined environment, may be used. For example an odd identity may be assigned the microchip packages, of which measurable quantity is less than or equal to a mean value. Correspondingly, an even identity may be assigned the microchip packages, of which measurable quantity is greater than the mean value.

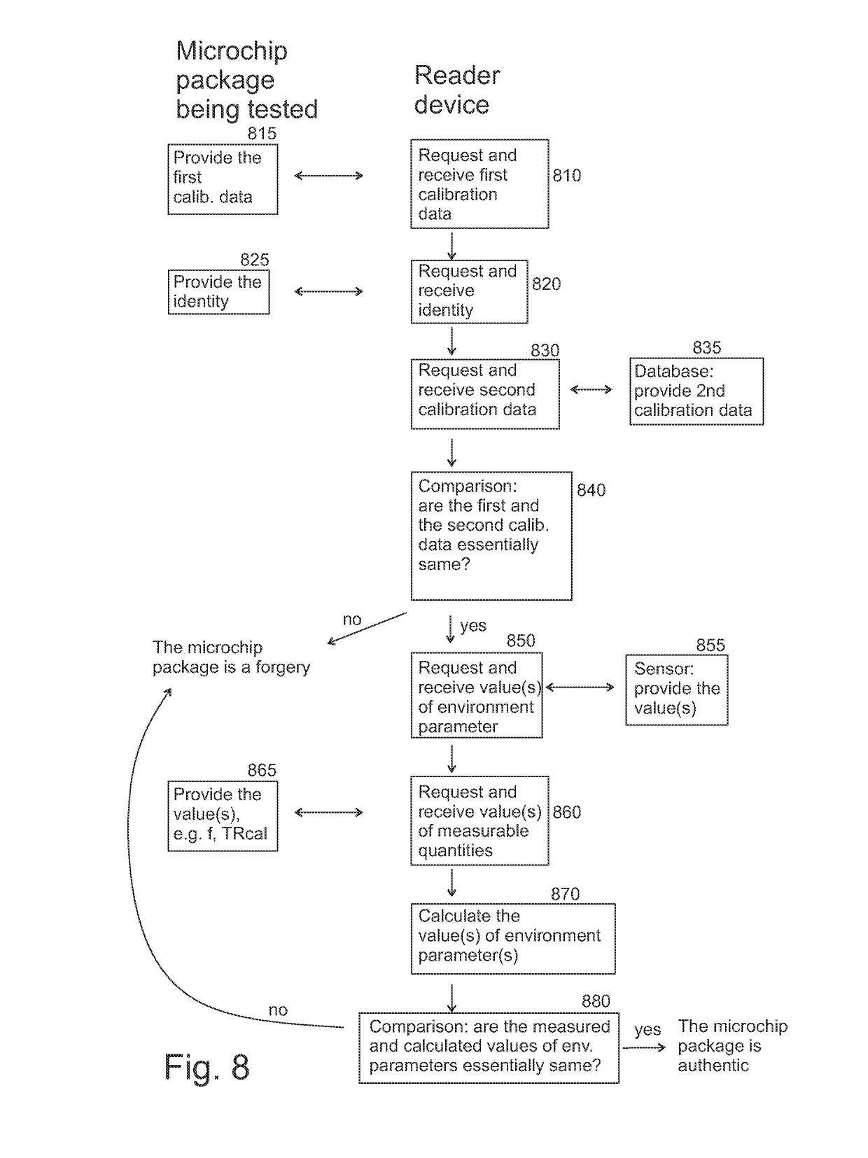

This embodiment is illustrated in FIG. 9a, where the cumulative distribution function 801 of a calibration correction factor b′₀ is shown. On the left hand side of zero, the values of the correction factor are less than or equal to zero (in the Figure: “b′₀≦Q”), and the identity number is odd (in the Figure: “ID=2N+1”). On the right hand side of zero, the values of the correction factor are greater than zero (in the Figure: “b′₀>0”), and the identity number is even (in the Figure: “ID=2N”). By definition of the cumulative distribution function 801 the label “Fraction” indicates the fraction of microchip packages having a calibration correction factor less than a given value. An offset OFF may also be used such that for a microchip package, of which calibration data comprises a correction factor less than or equal to zero, the identity of the form ID=2N+1+OFF, will be used. Similarly, for a microchip package, of which calibration data comprises a correction factor greater than zero, the identity of the form ID=2N+OFF, will be used. Such offsets may be used also in other embodiments, which will be discussed below.

If such microchips are produced without knowing the logical correspondence, in the previous case approximately only half of the microchip packages are determined fraudulent.

In general, the correction factors are distributed following a distribution function. To divide the microchip packages to several (say M) categories depending on the value of the correction factor, the inverse of the cumulative distribution function can be used. Using the inverse of the cumulative distribution function, the microchip packages can be classified to several categories such that each category comprises approximately an equal number of microchip packages. Then the identity number MN+i may be assigned to each microchip package belonging to the category i, wherein M is the number of categories, N is an integer (at least zero), and i=1, 2, 3, . . . , M. In this case only a small portion of the microchip packages, approximately 1/M, would pass the logical correspondence test. In case the correction factors are normally distributed, an inverse of the normal cumulative distribution function (CDF) may be used. This is illustrated in FIG. 9b for the case M=4. The limits for the categories are found from CDF. As one fourth of the microchips are assigned to each category, the category limits are found from the points where the CDF has the values 0, 0.25, 0.5, 0.75 and 1. The values of the inverse CDF at 0.25, 0.5, and 0.75 are −0.67, 0, and 0.67, respectively. These values are shown in the figure.

It is evident, that the index i in the identity number MN+i is not necessarily increasing with increasing correction factor. The categories may be sorted also differently.

It is also possible to define another functional relation between the identity and the categories. For example, the logical relation may be defined so that the calibration data value defines a first category (the category i, as discussed above) and a function of the identity defines a second category j. The logical relation may be that the first and the second categories are equal. As for the second category, e.g. a trigonometric function can be used. For example, the second category may be selected as j=1+max{floor[M(sin(A*ID)+1)/2,M−1}. Here A is an arbitrary constant and ID is the identity number of the microchip package. M is the number of categories as defined above. It is obvious that the number of the first categories and the number of the second categories is equal. The logical relation between the categories may thus by that i equals j.

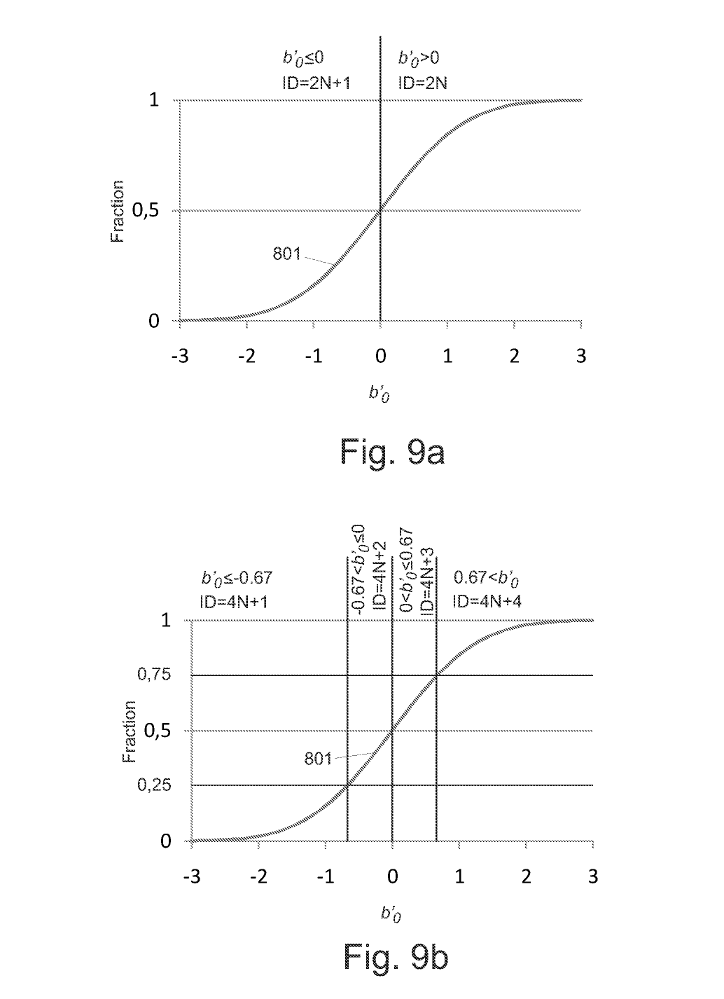

It is also possible to define another functional relation between the identity and the categories. The functional relation may relate a value v between zero and one (preferably excluding both ends) to each identity number. E.g. the relation v=(mod(ID,M)+0.5)/M, where mod(ID,M) is the reminder of the ID divided by a number of categories M (mod from “modulo”), relates a number between 0 and 1 to each identity number ID. Then, a logical relation can be defined such that the value of the calibration data (or a value of a measurable quantity in a predetermined environment) should be approximately Φ⁻¹(v), where Φ⁻¹ is the inverse cumulative distribution function of the calibration data. To be more specific, a logical relation might have the form Φ⁻¹(v)−ε₁<b′₀<Φ⁻(v)+ε₂, where b′₀ is the calibration data, v=(mod(ID,M)+0.5)/M, and ε₁ and ε₂ are tolerance values. Naturally the tolerance value may be equal: ε=ε₁=ε₂. Thus, given the ID and calibration data, or the ID and the value of a measurable quantity, one may check if the reference functional relation is satisfied or not. This is illustrated in FIG. 10 for two values of v. For a first identity number (say ID₁=11, M₁=5, and vᵢ=(mod(ID₁,M₁)+0.5)/M₁), a value v₁=0.3 may be obtained. The inverse CDF of v₁ is −0.52. Thus, for this identity number only values of −0.52−ε<b′₀<0.52+ε for the correction factor b′₀ are allowed. If another value is found, the microchip package may be considered a forgery. As for the second example, v₂=0.7, which may be obtained e.g. for ID₂=1018 and M₂=105 using v₂=(mod(ID₂,M₂)+0.5)/M₂. For this identity number only values of 0.25−ε<b′₀<0.25+ε for the correction factor b′₀ are allowed.

The approach is close to the one described earlier together with embodiment (e), but in contrast to predefined categories for the calibration data, now the reference function, when applied to the identity number, defines an approximate value for the calibration data. It is further noted that the vendor calibrates the microchip packages and assigns the identity numbers, and is therefore free to sort the microchip packages accordingly.

Embodiment (e) was discussed in the context of calibration data and microchip package identity. However, in a known environment, the microchip packages may be sorted to the different categories using the value of a measurable quantity. The distribution function of the value of the measurable quantity in the known environment may be used to define the limit of the categories, as discussed above in the context of calibration data. In this case, the embodiment may be applied e.g. in addition to the embodiments (a) and (b). The ranges for the different categories of the measurable quantity may depend on the environment, e.g. on the temperature. Therefore, the authenticity may be determined using at least the truth-value. The authenticity may be determined using the truth-value, a value of a measurable quantity and a reference value for the measurable quantity.

It is noted, that the embodiment (e) may be applied also in addition to the previously described embodiments (c) and (d), where the calibration data is used. Therefore, the authenticity may be determined using at least the truth-value. The authenticity may be determined using the truth-value, a calculated value for the environment parameter and a reference value for the environment parameter. Moreover, the embodiment (e) may be used in addition to the embodiments (a) and (b) provided that embodiment (e) is applied using the values of the measurable quantities. Alternatively, the embodiment (e) may be used in addition to the embodiments (a) and (b) using the calibration data, provided that calibration data is received.

In the embodiment (f), the authenticity of a set of microchips may be determined e.g. by using the method (e) for a single chip applied to a set of microchip packages. In the embodiment (e) it was assumed that the calibration data and identity of each microchip package satisfies a logical relation or that the value of the measurable quantity and identity of each microchip package satisfies a logical relation. Therefore 100% of the microchip packages satisfies the relation. For a set of microchip packages it is possible to predetermine a ratio α that does not satisfy the logical relation. Therefore a is the percentage of microchip packages, that need to fail the logical relation test. In the embodiment (e), α is zero, and the test can be applied to each microchip package individually. However, in that case the logical relation may be relatively easy to find out by the microchip package forger. Therefore a larger α, say 10%, may make it harder to find out the relation, and the value of α itself.

The embodiment (f) can only be applied to a set of microchip packages, as the method requires to perform the logical test for many microchip packages and the determination of the percentage of microchip packages failing the test. The authenticity may be determined using at least the multiple truth-values. The authenticity may be determined using the multiples truth-values, and a statistical measure of difference between distribution, as will be discussed in the context of embodiments (g) and (h).

Embodiment (g) uses the statistical distribution of calibration data to determine the authenticity of the microchip packages. Calibration data from a set of microchip packages is received, e.g. from a set of microchip packages. Either a statistical measure of the calibration data or an estimate φₑₛₜ of the distribution function or cumulative distribution function describing the distribution of the calibration data is formed using the received values. The statistical measure can be compared to a reference statistical measure. The estimate of the density function can be compared to a reference distribution function φ_{ref}. If either of the deviation is too large, the all microchip packages in set of microchip packages are considered forgeries. In the embodiment, a statistical measure of difference is calculated. If the statistical measure of difference is too large, the microchip package may be considered fraudulent. Examples for the statistical measure of difference include
difference between the average values of the measured and reference distributions,
difference between the standard deviations of the measured and reference distributions,
difference between the skewness of the measured and reference distributions,
any norm for the difference function d(x)=φₑₛₜ(x)−φ_{ref}(x).

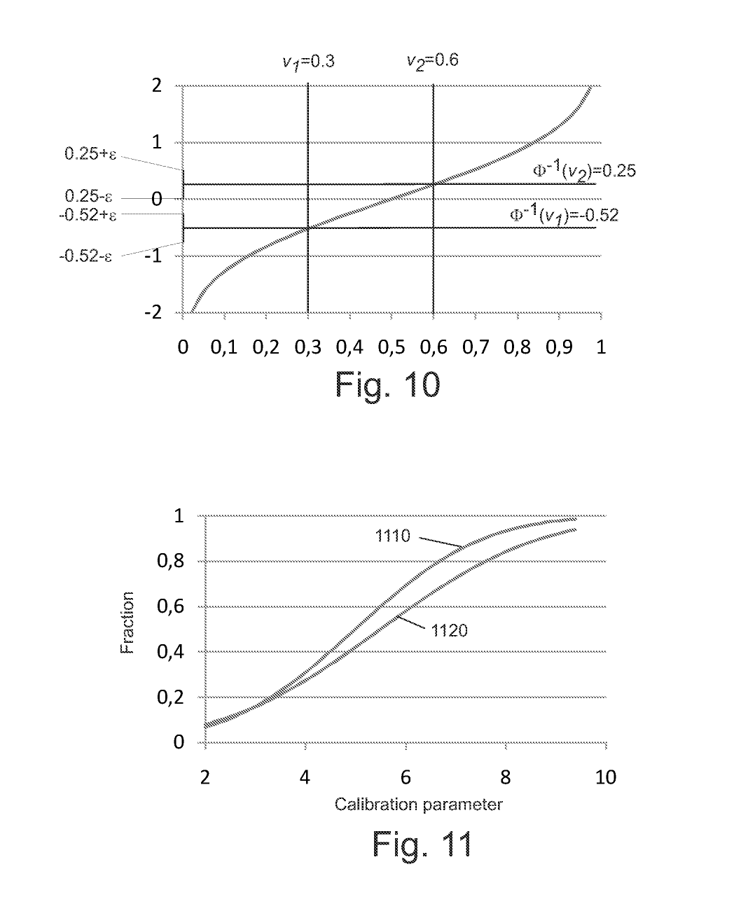

FIG. 11 shows two cumulative distribution functions of a calibration datum, e.g. the value of the slope b₁: a reference cumulative distribution function φ_{ref} 1120 and an estimate of a cumulative distribution function φₑₛₜ 1110. By comparing the reference function 1120 with the estimated function 1110 the authenticity of the set of microchip packages may be determined. It is also noted that in FIG. 11, the standard deviation of the estimated function 1110 is larger than the standard deviation of the reference function 1120. Therefore, the authenticity of the set of microchip packages may be determined by comparing the standard deviations.

Embodiment (h) is in principle similar to embodiment (g). However, instead of having a reference distribution function for the calibration data, a reference distribution function for the measurable quantity can be used. It should be noted, that the reference distribution function depends on the environment, where the values are measured. The estimated distribution function may be compared with a reference distribution function, or some statistical measure of the estimated distribution function may be compared with the same statistical measure of the reference distribution function.

The application of the embodiments (e) and (f) also require a method for assigning an identity for a microchip package. In the method, the identity of a microchip package is assigned based on calibration data of the microchip package or on the value of a measurable quantity, the value being measured with the microchip package in a known environment. The method may comprise
determining a number of categories M,
determining limits V_{min,i} and V_{max,i} for each category i, i=1, 2, 3, . . . , M
determining a value v, the value v being indicative of calibration data of the microchip package or of a value of a measurable quantity, the value of the measurable quantity being measured with the microchip package,
using the limits and the value v, determining a category i such that V_{min,i}<v≦V_{max,i}

As has been discussed above, the cumulative distribution function of v give a one-to-one correspondence between the percentile values of v and the limits V_{min,i} and V_{max,i}. Therefore, e.g. different percentiles for v may determine the values for the limits V_{min,i} and V_{max,i}. The identity of the microchip package may be assigned e.g. such that
initially set the number of microchip devices in the category i, Nᵢ, zero, wherein 1=1, 2, 3, . . . , M
determine a first category i using the limits and the value v as discussed above,
assign the identity NᵢM+i to the microchip package, and
advance the number Nᵢ by one, e.g. set the value Nᵢ+1 to the counter Nᵢ.

Alternatively, the identity of the microchip package may be assigned e.g. such that
initially set a counter, N, to an initial value, e.g. zero or one,
using the counter N, determining a second category j such that j=1, 2, 3, . . . M
selecting a microchip package such that the first category i of the microchip package, as discussed above, equals the second category j,
for the selected microchip package, assign the identity N, and
advance the number N by one, e.g. set the value N+1 to the counter N.

In addition, the categories are not necessarily used for assigning an identity to a microchip package. As discussed above, the identity may be selected such that a logical relation of the form: Φ⁻¹(v)−ε₁<b′₀<Φ⁻(v)+ε₂, where b′₀ is the calibration data, v is a function of the identity ID, e.g. v=(mod(ID,M)+0.5)/M, and ε₁ and ε₂ are tolerance values, is obeyed. In this case, there is an allowed range [r₁(ID), r₂(ID)], to which the calibration data (or the value of a measurable quantity in an environment) should belong. I.e. given the ID, the calibration data b′₀ is from r₁(ID) to r₂(ID). In this case, the identity of the microchip package may be assigned e.g. such that
initially set a counter, N, to an initial value, e.g. zero or one,
using the counter N, determining the minimum, r₁(N), and the maximum, r₂(N), of an allowed range,
selecting a microchip package such that r₁(N)≦b′₀≦r₂(N), wherein b′₀ is the calibration datum for the microchip package or the value of a measurable quantity in an environment for the microchip package,
for the selected microchip package, assign the identity N, and
advance the number N by one, e.g. set the value N+1 to the counter N.

In selecting the minimum and maximum, e.g. the values r₁(ID)=Φ⁻¹(v(ID))−ε₁ and r₂(ID)=Φ⁻¹(v(ID))+ε₂ may be used. The tolerance values ε₁ and ε₂ may be selected to be equal, as discussed above.

The methods may be performed using a device such as a computer. The computer may be comprised in an RFID reader device. The device may also be separate from an RFID reader device, and arranged to receive data from the RFID reader device, from the RFID reader device over an interface, from a database, from a database over an interface, or over an interface in general. In addition, the device may be arranged to receive reference information from a sensor, a database, or over an interface in general. The device may be arranged to perform any of the methods. The device may be e.g. one of a reader device and a computer.

The device comprises
means for receiving a value of a measurable quantity, the value of the measurable quantity being measured using the sensing element, and the value of the measurable quantity being indicative of an environment,
means for receiving reference information indicative of the environment, and
a data processor, arranged to use the received value of a measurable quantity and the reference information to determine the authenticity of the article comprising the microchip package.

The means for receiving a value of a measurable quantity may be one of
a reader device, arranged to measure the value of the measurable quantity from the sensing element 57,
means for accessing an interface, over which the value is received,
a database, in which the value is stored.

The means for receiving reference information indicative of the environment may be one of
a sensor, arranged to measure a reference value for the environment parameter
means for accessing an interface, over which the information is received,
a database, in which the information is stored,
a combination of a sensor and means for accessing an interface, or
a combination of a sensor and a database.

For example, the database may comprise reference value for the measurable quantity in many environments, and the reference value provided by the sensor may be used to select the correct reference data. An interface may also be accessed with the reference value provided by the sensor. It is also possible that the reference information is stored in an external database. The external database may be accessed over an interface, and the external database may comprise a sensor arranged to measure the reference value for the environment parameter.

The data processor may be arranged to perform at least one of the calculations and the comparisons of any of the embodiments of the method described above.

The device may further comprise means for receiving an identity of the microchip package comprised by the article. The device may comprise means for accessing a database or an interface using the identity. The value of a measurable quantity may be received using the identity. The reference information may be received using the identity. The device may comprise means for accessing a database or an interface using the identity and the reference value provided by the sensor.

The device may comprise a data processor and a memory. The device may be operated using a computer program. The computer program comprises computer program code, which when executed by the data processor is for executing the method for determining the authenticity of an article comprising a microchip package. The computer program code may be stored on a computer-readable medium. The computer program may be used for determining the authenticity of an article comprising a microchip package. The computer program code may be stored in the memory of the device. Furthermore, the computer program may be supplied as a computer program product comprising computer program code embodied on a non-transitory computer-readable medium. The computer program code is configured to, when executed on at least one data processor, cause a computer system to execute the method for determining the authenticity of an article comprising a microchip package.

In addition, another computer program comprises computer program code, which when executed by the data processor is for executing the method for assigning an identity for a microchip package. The computer program code may be stored on a computer-readable medium. Furthermore, the computer program may be supplied as a computer program product comprising computer program code embodied on a non-transitory computer-readable medium. The computer program code is configured to, when executed on at least one data processor, cause a computer system to execute the method for assigning an identity for a microchip package.

The different embodiments, as discussed above, makes it extremely hard to forge a microchip package. The method puts to use the observed fact that each microchip package comprising a sensing element behaves in a different manner in an environment, the sensing element being arranged to sense the environment. Therefore, forgery by simply copying the data from a first microchip to a second microchip can be detected, as the second microchip does not function as the first microchip. As forgery of a microchip package can be detected, forgery of any type of security documents comprising a microchip package can be detected with the method.

1. A method for determining an authenticity of an article comprising a microchip package, the microchip package comprising a sensing element, the method comprising:
receiving a value of a measurable quantity, the value of the measurable quantity being measured using the sensing element, and the value of the measurable quantity being indicative of an environment;
receiving reference information indicative of the environment; and
using the received value of a measurable quantity and the reference information to determine the authenticity of the article comprising the microchip package.

2. The method according to claim 1, wherein the reference information comprises a reference value for the measurable quantity corresponding to the environment, the method further comprising:
determining the authenticity of the article comprising the microchip package by comparing the received value of a measurable quantity with the reference value for the measurable quantity.

3. The method according to claim 2, further comprising:
receiving a second value of the measurable quantity or another measurable quantity, the second value being measured using the sensing element or another sensing element, and the second value being indicative of a second environment, wherein the reference information comprises a first reference value for the measurable quantity corresponding to the environment, and wherein the reference information comprises a second reference value for the second value of the measurable quantity or another measurable quantity; and
determining the authenticity of the article comprising a microchip package by
comparing the received value of a measurable quantity with the first reference value and
comparing the second received value of the measurable quantity or another measurable quantity with the second reference value.

4. The method according to claim 1, wherein
the reference information comprises a reference value for the environment parameter, and the method comprises
receiving calibration data for the microchip package,
using the calibration data and the value of a measurable quantity to determine a value of an environment parameter, and
determining the authenticity of the article comprising a microchip package by comparing the determined value of an environment parameter with the reference value for the environment parameter.

5. The method according to claim 4, further comprising:
receiving reference calibration data for the microchip package; and
determining the authenticity of the article comprising a microchip package further by comparing the calibration data with the reference calibration data.

6. The method according to claim 1, further comprising:
receiving multiple values of a measurable quantity, the values of the measurable quantity being measured from a set of articles comprising a microchip package, the microchip packages comprising a sensing element, the set of articles comprising the article of which authenticity is determined, wherein
the reference information comprises information on a reference distribution for the values of the measurable quantity,
calculating a statistical measure of difference using the received multiple values of a measurable quantity and the reference distribution, and
determining the authenticity of the microchip package using the statistical measure of difference.

7. The method according to claim 1, further comprising:
receiving an identity of the microchip package,
using the value of the measurable quantity and the identity, determining a truth-value of a logical correspondence between the value of the measurable quantity and the identity, and
using the at least the truth-value to determine the authenticity of the article comprising the microchip package.

8. The method according to claim 1, further comprising:
receiving an identity of the microchip package;
receiving calibration data for the microchip package;
using the calibration data and the identity, determining a truth-value of a logical correspondence between the calibration data and the identity; and
using the at least the truth-value to determine the authenticity of the article comprising the microchip package.

9. The method according to claim 6, further comprising:
receiving multiple identities, the identities being indicative of microchips of a set of articles comprising a microchip package, the set of articles comprising the article comprising a microchip package;
receiving calibration data for the microchip packages comprised in the set of articles comprising a microchip package;
using the calibration data and the multiple identities, determining multiple truth-values of a logical correspondence between the calibration data and the identities; and
determining the authenticity of the microchip package using at least the multiple truth-values.

10. A computer program product, comprising:
a non-transitory computer readable medium; and
computer program code recorded on the computer readable medium, which when executed by a data processor is for executing a method for determining an authenticity of an article comprising a microchip package, the microchip package comprising a sensing element, the method comprising:
receiving a value of a measurable quantity, the value of the measurable quantity being measured using the sensing element, and the value of the measurable quantity being indicative of an environment;
receiving reference information indicative of the environment; and
using the received value of a measurable quantity and the reference information to determine the authenticity of the article comprising the microchip package.

11. An apparatus for determining an authenticity of an article comprising a microchip package, the microchip package comprising a sensing element, the apparatus comprising:
a first receiving module configured to receive a value of a measurable quantity, the value of the measurable quantity being measured using the sensing element, and the value of the measurable quantity being indicative of an environment;
a second receiving module configured to receive reference information indicative of the environment; and
a data processor arranged to use the received value of a measurable quantity and the reference information to determine the authenticity of the article comprising the microchip package.

12. The apparatus according to claim 11, wherein the first receiving module comprises a reader device arranged to receive the value of a measurable quantity.

13. The apparatus according to claim 11, further comprising:
a sensor arranged to measure a reference value for the environment parameter.

14. The apparatus according to claim 14, further comprising:
an access module configured to access a database or an interface using the measured reference value for the environment parameter.

15. The apparatus according to claim 12, further comprising:
a third receiving module configured to receive an identity of the microchip package; and
an access module configured to access a database or an interface using the identity of the microchip package.

16. The apparatus according to claim 15, further comprising:
a sensor arranged to measure a reference value for the environment parameter; and
an access module configured to access a database or an interface using the measured reference value for the environment parameter and the identity.

17. The apparatus according to claim 15, wherein
the database comprises calibration data for the microchip package, or
the interface is configured to be accessed for receiving calibration data of the microchip package.

18. The apparatus according to claim 11, further comprising:
a third receiving module configured to receive multiple values of a measurable quantity, the values of the measurable quantity being measured from a set of articles comprising a microchip package, the microchip package comprising a sensing element, the set of articles comprising the article of which authenticity is determined,
wherein the data processor is arranged to calculate a statistical measure of difference using the received multiple values of a measurable quantity and the reference information, and wherein the data processor is arranged to determine the authenticity of a microchip package using the statistical measure of difference.
